(19) United States
(12) Patent Application Publication
(10) Pub. No.: US 2018/0030899 A1
(43) Pub. Date: Feb. 1, 2018

(54) STRUCTURE FOR SUPPORTING SPARK PLUG FOR GAS TURBINE ENGINE

(71) Applicant: HONDA MOTOR CO., LTD., Tokyo (JP)

(72) Inventors: Yasuharu Kamoi, Wako-shi (JP); Kohei Nishimura, Wako-shi (JP); Daisuke Kato, Wako-shi (JP)

(21) Appl. No.: 15/220,539

(22) Filed: Jul. 27, 2016

(51) Int. Cl. F02C 7/266; F23R 3/00

(52) U.S. Cl. CPC F02C 7/266; F23R 3/002; F05B 2220/302; F05D 2220/32; F05D 2260/99

(57) ABSTRACT

Since a wall part of a combustor of a gas turbine engine includes a cylindrical flange projecting integrally from an outer periphery of a spark plug fitting hole, and a spark plug support device covering an extremity of a spark plug is welded or brazed to the flange, a welded or brazed site of the device is above the flange lower in temperature than the wall part, and it is possible to suppress decrease in strength at the welded or brazed site and to improve durability, and also to reduce cost since a shape of the device may be coincided with a simple shape of the flange and machining of the device becomes easy. Since the flange is formed integrally with the wall part, compared with a case where the flange is formed from a separate member, the number of components and machining steps is decreased, enabling further cost reduction.

### FIELD OF THE INVENTION

The present invention relates to a structure for supporting a spark plug for a gas turbine engine in which an extremity of the spark plug is covered with spark plug support means encircling a spark plug fitting hole formed in a wall part of a combustor of the gas turbine engine.

### DESCRIPTION OF RELATED ART

Such a structure for supporting a spark plug for a gas turbine engine is known from Japanese Patent Application Laid-open No. 2009-185821. With regard to this invention, one end of an annular hollow shaft 14 (flange) is fitted into and fixed by welding to an opening formed in a wall part of a combustor chamber 1, a floating spark plug sleeve 120 (spark plug support collar) is supported in a floating state on the other end of the hollow shaft 14 via a hollow shaft sleeve 130 (collar support member), and an extremity of a spark plug 13 is made to extend through the floating spark plug sleeve 120.

In this conventional arrangement, since the hollow shaft 14 is directly welded to the opening formed in the wall part of the combustor chamber 1, there is a possibility that strength of a peripheral edge of the opening will be degraded by heat of welding and a crack will occur. Moreover, in order to weld the hollow shaft 14 to the wall part of the combustor chamber 1, which is formed with a complicated three-dimensional curved surface, it is necessary to machine a weld part of the hollow shaft 14 with good precision in conformity with the three-dimensional curved surface, and there is a problem that machining cost is high.

### SUMMARY OF THE INVENTION

The present invention has been accomplished in light of the above circumstances, and it is an object thereof to prevent durability from being degraded due to welding or brazing of spark plug support means to a combustor and to simplify a shape of the spark plug support means to thus cut machining cost.

In order to achieve the object, according to a first aspect of the present invention, there is provided a structure for supporting a spark plug for a gas turbine engine in which an extremity of the spark plug is covered with spark plug support means encircling a spark plug fitting hole formed in a wall part of a combustor of the gas turbine engine, wherein the wall part of the combustor comprises a cylindrical flange projecting integrally from an outer periphery of the spark plug fitting hole, and the spark plug support means is welded or brazed to the flange.

In accordance with the first aspect, the extremity of the spark plug is covered with the spark plug support means encircling the spark plug fitting hole formed in the wall part of the combustor of the gas turbine engine. Since the wall part of the combustor includes the cylindrical flange projecting integrally from the outer periphery of the spark plug fitting hole, and the spark plug support means is welded or brazed to the flange, the site of welding or the site of brazing of the spark plug support means is above the flange, which is at a lower temperature than that of the wall part of the combustor, and not only is it possible to suppress any decrease in the strength at the site of welding or the site of brazing and to improve the durability, but it is also possible to reduce the cost since the shape of the spark plug support means may be made to coincide with the simple shape of the cylindrical flange and machining of the spark plug support means becomes easy. Moreover, since the flange is formed integrally with the wall part of the combustor, compared with a case in which the flange is formed from a separate member, the number of components and the number of machining steps can be decreased, and it becomes possible to further reduce the cost.

According to a second aspect of the present invention, in addition to the first aspect, a plurality of cooling holes for supplying air for cooling to an interior of the combustor are formed in a whole circumference of the spark plug fitting hole except for the flange in the wall part of the combustor.

In accordance with the second aspect, since the plurality of cooling holes for supplying air for cooling to the interior of the combustor are formed in the whole circumference of the spark plug fitting hole except for the flange in the wall part of the combustor, the cooling hole can be formed in the wall part very close to the spark plug fitting hole without being hindered by the spark plug support means, thus ensuring the effect in cooling the area around the spark plug fitting hole and thereby preventing the strength from being degraded by heat.

Note that a combustor main body part 12 of an embodiment corresponds to the wall part of the present invention.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 to FIG. 4 show an embodiment of the present invention: FIG. 1 is a longitudinal sectional view of a combustor of a gas turbine engine; FIG. 2 is an enlarged view of part 2 in FIG. 1; FIG. 3 is a view in a direction of arrow 3 in FIG. 2; and FIG. 4 is a view, corresponding to FIG. 3, showing a comparative example.

### DESCRIPTION OF THE PREFERRED EMBODIMENT

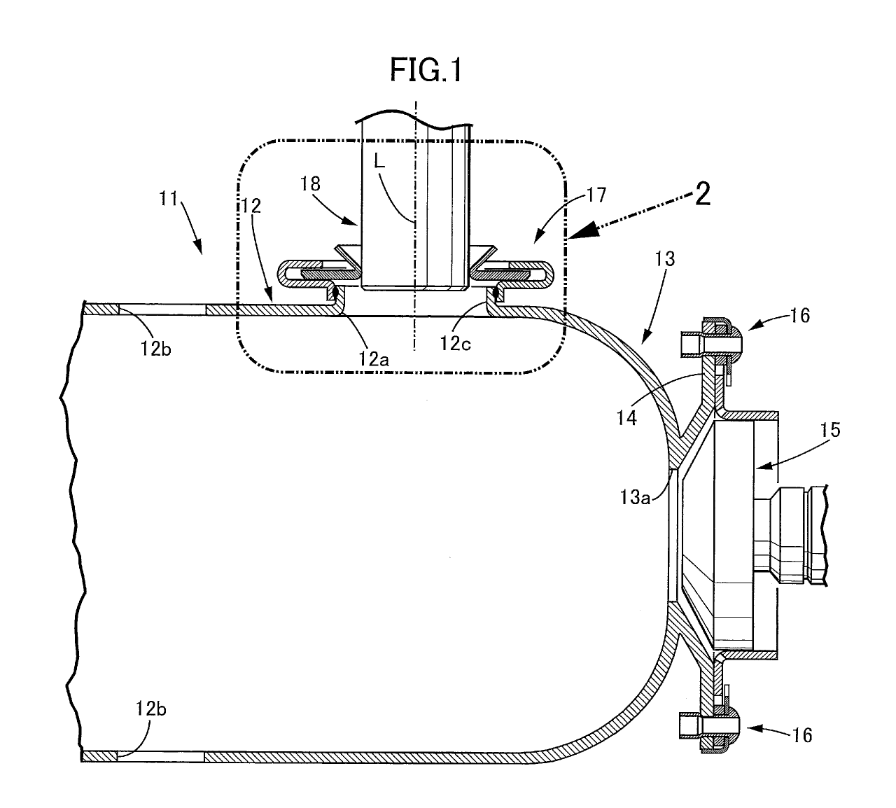

An embodiment of the present invention is explained below by reference to FIG. 1 to FIG. 4.

As shown in FIG. 1, a combustor 11 disposed so as to encircle an engine axis of a gas turbine engine includes an annular combustor main body part 12 and a dome part 13 blocking one end part of the combustor main body part 12. A plurality of open flange parts 14 are disposed, at equal intervals on a circumference having the engine axis as the center, on the semicircular cross section dome part 13, and the extremities of fuel nozzles 15 for injecting fuel into the interior of the combustor 11 via fuel supply holes 13a formed in the center of the open flange parts 14 are covered with a nozzle guide 22 supported in a floating state by nozzle guide support means 16. Furthermore, a plurality of spark plug fitting holes 12a are formed in an outer peripheral wall of the combustor main body part 12 at equal intervals in the circumferential direction, and the extremities of spark plugs 18 are inserted into spark plug support collars 20 supported in a floating state by spark plug support means 17 provided on the spark plug fitting holes 12a.

The combustor 11 is cantilever-supported on a casing of the gas turbine engine via an inner peripheral part thereof, and since base end parts of the fuel nozzles 15 and the spark plugs 18 are cantilever-supported on the casing, the fuel nozzles 15 and the spark plugs 18 move relative to the combustor 11 due to a difference in the amount of thermal expansion of each part accompanying change in temperature of the gas turbine engine. In order to allow this relative movement, the extremities of the fuel nozzles 15 are covered with the nozzle guide 22 supported on the nozzle guide support means 16 in a floating state, and the extremities of the spark plugs 18 are inserted into spark plug support collars 20 supported by the spark plug support means 17 in a floating state. Formed in the outer peripheral wall and an inner peripheral wall of the combustor main body part 12 are a plurality of air inlet holes 12b for introducing air for combustion into the interior of the combustor 11.

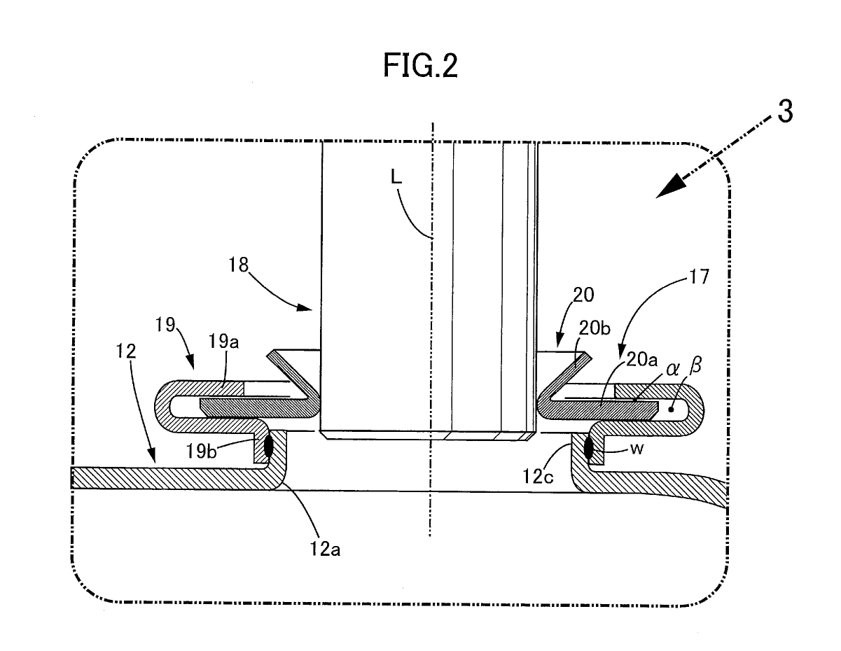

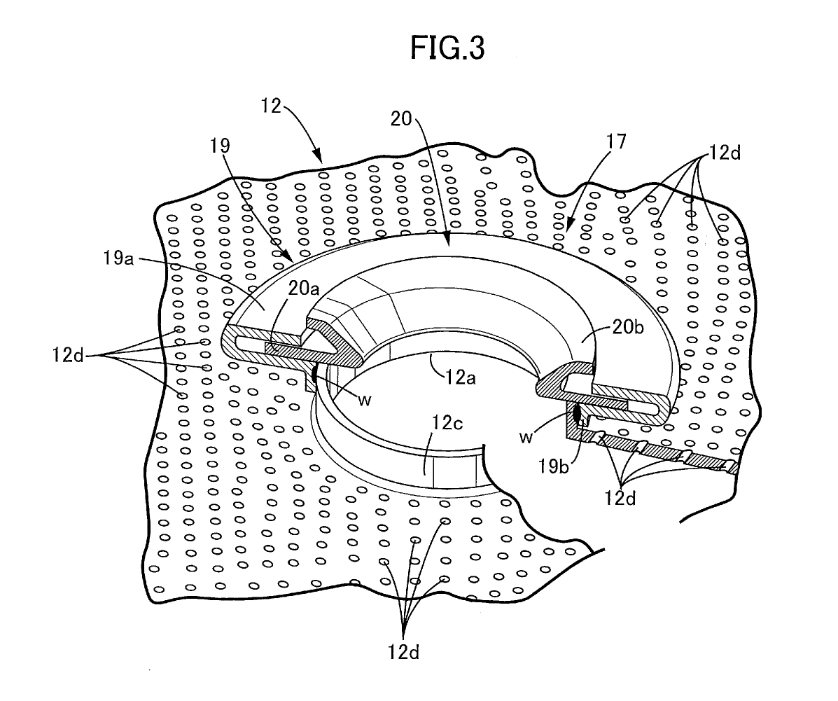

The structure of the spark plug support means 17 is now explained by reference to FIG. 2 and FIG. 3.

A cylindrical flange 12c is projectingly provided integrally with an outer peripheral face of the combustor main body part 12 by burring, and the spark plug fitting hole 12a is formed from the inner periphery of the flange 12c. The spark plug support means 17, which is disposed so as to encircle an axis L of the spark plug 18, includes an annular collar support member 19 and the annular spark plug support collar 20.

The collar support member 19 integrally includes an annular support portion 19a that has a J-shaped cross section and opens inward in the radial direction and a cylindrical flange 19b that projects from the inner periphery of the support portion 19a toward the spark plug fitting hole 12a side along the axis L, the flange 19b being fitted around the outer periphery of the flange 12c of the combustor main body part 12 and joined by a weld w.

The spark plug support collar 20 includes a disk-shaped flat portion 20a that is loosely fitted into the support portion 19a of the collar support member 19 and a guide portion 20b that enlarges conically from the inner periphery of the flat portion 20a in going radially outward along the axis L, the guide portion 20b covering the extremity of the spark plug 18. Formed between the collar support member 19 and the spark plug support collar 20 are a gap α in the axis L direction and a gap β in the radial direction, the spark plug support collar 20 being supported in a floating state with respect to the collar support member 19 in the range of the gaps α and β.

Formed in a wall part of the combustor main body part 12 are a large number of cooling holes 12d (see FIG. 3) for introducing air for cooling into the interior of the combustor 11. The cooling holes 12d are formed in the entire region of the wall part of the combustor main body part 12 except the flange 12c and are formed up to a position that is as close as possible to the whole circumference of the flange 12c.

The operation of the embodiment of the present invention having the above arrangement is now explained.

During running of the gas turbine engine, air that has been compressed by a compressor is supplied to a space around the combustor 11 and is supplied therefrom to the interior of the combustor 11 after passing through the air inlet holes 12b of the combustor main body part 12 and the interior of the fuel nozzles 15, and the air is mixed with fuel injected from the fuel nozzle 15 in the interior of the combustor 11, thus carrying out combustion. Combustion gas generated by combustion is discharged from the combustor 11 and drives a turbine, and is then discharged via an exhaust nozzle and generates thrust. The spark plugs 18 ignite the mixed gas when the gas turbine engine is started, and combustion of the mixed gas continues automatically after starting the gas turbine engine.

Since the annular combustor 11 is cantilever-supported on the casing of the gas turbine engine via its inner peripheral part, and the base end parts of the fuel nozzles 15 and the spark plugs 18 are also cantilever-supported on the casing of the gas turbine engine, the fuel nozzles 15 and the spark plugs 18 move relative to the combustor 11 due to differences in the amount of thermal expansion accompanying change in temperature of the gas turbine engine. However, the spark plug 18 is inserted into and supported on the spark plug support collar 20, which is supported by the spark plug support means 17 in a floating state on the flange 12c encircling the spark plug fitting hole 12a of the combustor main body part 12, the spark plug support collar 20 supporting the spark plug 18 can move relative to the collar support member 19 in the axis L direction in the range of the gap α and in the radial direction in the range of the gap β, and the above relative movement is thereby allowed due to the action of the gaps α and β.

In order to cool the combustor main body part 12, whose temperature increases due to combustion of the air-fuel mixture, air is introduced through the cooling holes 12d extending through the wall face of the combustor main body part 12, the air forms a thin film of air on the inner wall face of the combustor main body part 12, and the combustor main body part 12 is thereby cooled effectively, thus preventing the durability from being degraded.

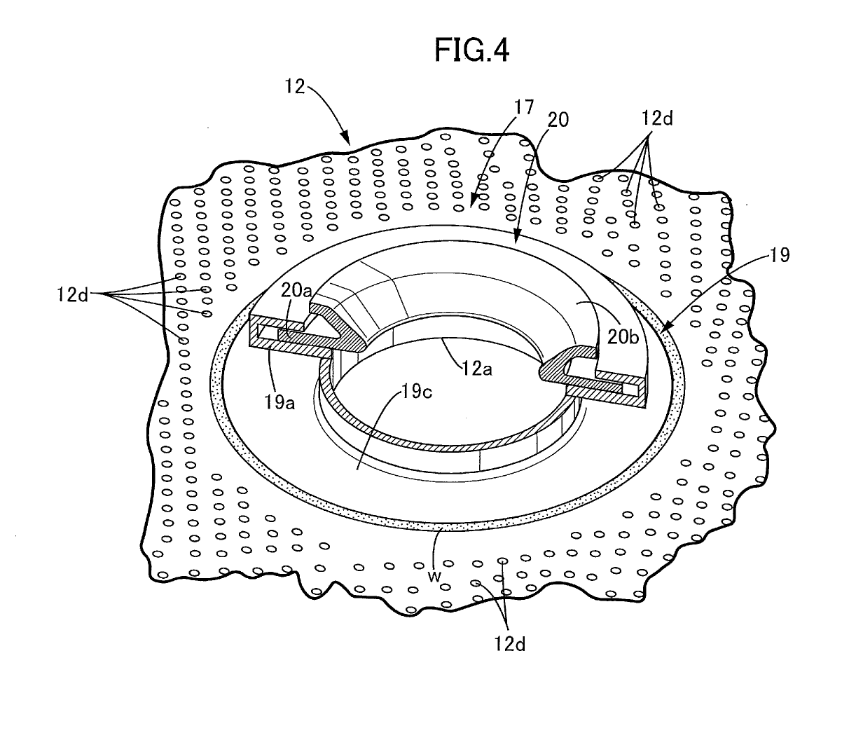

FIG. 4 shows a comparative example of spark plug support means 17; with regard to the spark plug support means 17 of the comparative example, a collar support member 19 includes a large diameter flange 19c connected to a support portion 19a, and this flange 19c is directly welded with a weld w to a section around a spark plug fitting hole 12a in a wall part of a combustor main body part 12. Since a hole opening in a weld part is blocked during welding, there is the problem that a region of about a few mm long without a hole occurs around the weld part as the center, and if an attempt is made to machine cooling holes 12d after welding, the cost increases.

On the other hand, with regard to the spark plug support means 17 of the present embodiment shown in FIG. 3, since the collar support member 19 is welded with a weld w to the cylindrical flange 12c encircling the spark plug fitting hole 12a, the cooling holes 12d can be formed as close to the whole circumference of the spark plug fitting hole 12a as possible without being hindered by the spark plug support means 17, thus improving the effect in cooling the combustor main body part 12.

Moreover, as in the comparative example shown in FIG. 4, if an attempt is made to weld the collar support member 19 of the spark plug support means 17 with a weld w directly to the wall part of the combustor main body part 12, which has a three-dimensional curved face, there is the problem that machining for making the shape of the weld face of the collar support member 19 coincide with the shape of an outer surface of the combustor main body part 12 is difficult and becomes a main cause for an increase in cost, but in accordance with the present embodiment, since the collar support member 19 of the spark plug support means 17 is welded with the weld w to the flange 12c, which has a simple cylindrical shape, it becomes unnecessary to subject the collar support member 19 to difficult machining, and it is possible to reduce the cost.

Furthermore, the wall part of the combustor main body part 12, which is directly exposed to flame during running of the gas turbine engine, attains a higher temperature than that of the flange 12c, which projects from the wall part. As shown in FIG. 4, if the spark plug support means 17 is directly welded to the wall part of the combustor main body part 12, the wall part of the combustor main body part 12 is degraded by the heat of welding, and if it attains a high temperature due to the heat of running of the gas turbine engine, there is a possibility that a crack, etc. will occur and the durability will be degraded. However, in accordance with the present embodiment, even if the flange 12c is degraded due to the heat of welding the spark plug support means 17, since the flange 12c is maintained at relatively low temperature during running of the gas turbine engine, there is no possibility of a crack, etc. occurring and the durability being degraded.

Moreover, since the flange 12c is formed integrally with the wall part of the combustor main body part 12 by burring, compared with a case in which the flange 12c is formed from a separate member, the number of components and the number of machining steps can be decreased, and it becomes possible to further reduce the cost.

An embodiment of the present invention is explained above, but the present invention may be modified in a variety of ways as long as the modifications do not depart from the gist thereof.

For example, in the embodiment the flange 12c is formed by burring, but it may be formed by press forming.

What is claimed is:

1. A structure for supporting a spark plug for a gas turbine engine in which an extremity of the spark plug is covered with spark plug support means encircling a spark plug fitting hole formed in a wall part of a combustor of the gas turbine engine, wherein the wall part of the combustor comprises a cylindrical flange projecting integrally from an outer periphery of the spark plug fitting hole, and the spark plug support means is welded or brazed to the flange.

2. The structure for supporting a spark plug for a gas turbine engine according to claim 1, wherein a plurality of cooling holes for supplying air for cooling to an interior of the combustor are formed in a whole circumference of the spark plug fitting hole except for the flange in the wall part of the combustor.
